(19) United States
(12) Patent Application Publication
(10) Pub. No.: US 2007/0272529 A1
(43) Pub. Date: Nov. 29, 2007

(54) Integrated Circuit With Analog Connection Matrix

(75) Inventor: Josep Montanya Silvestre, Rubi (Barcelona) (ES)

Correspondence Address: STAAS & HALSEY LLP, SUITE 700, 1201 NEW YORK AVENUE, N.W., WASHINGTON, DC, 20005, US

(73) Assignee: BAOLAB MICROSYSTEMS S.L., 08220-TERRASSA, BARCELONA SPAIN (ES)

(21) Appl. No.: 11/578,722

(22) PCT Filed: Apr. 14, 2005
(86) PCT No.: PCT/EP05/04147

§ 371 Date: Oct. 18, 2006

(30) Foreign Application Priority Data
Apr. 19, 2004 (ES) 200400945

(51) Int. Cl. H01H 57/00

(52) U.S. Cl. 200/181

(57) ABSTRACT

Integrated circuit with analog connection matrix. The integrated circuit includes an analog connection matrix having a plurality of analog i/o contacts. The analog i/o contacts have a plurality of electric interconnections with respect to one another through miniaturized relays, in which each miniaturized relay includes a conductive element arranged in said intermediate space, said conductive element being suitable for effecting a movement between a first position and a second position depending on a control electromagnetic signal and said conductive element opening or closing an electric circuit depending on whether it is in said first position or in said second position.

### FIELD OF THE INVENTION

The invention relates to an integrated circuit comprising at least an analog connection matrix, wherein the analog connection matrix has a plurality of analog i/o (input/output) contacts that have a plurality of mutually electric interconnections through connection elements.

In the present description and claims the expression integrated circuit has been used to refer either an integrated monolithic circuit, internally containing a only one silicon block, and a hybrid integrated circuit, containing more than a silicon block. It also refers to integrated circuits of the SiP type (“System in a Package”) or HDP (High Density Package), which are complex hybrid integrated circuits, which can comprise discrete elements such as for example resistors, condensers and/or coils, in the interior of the plastic encapsulation. An example of SiP is Pentium III® by INTEL.

### STATE OF THE ART

Digital connection matrixes, allowing to establish electric connections between i/o contacts of the matrix, so that a certain digital signal of a i/o contact can be transmitted to another i/o contact are known. Likewise other analog connection matrixes performing a similar function are known, although they operate in a different form: digital connection matrixes only establish connections from input(s) to output(s) without existing an actual electric connection between both of them, but there is a digital circuit receiving the digital input signal and regenerating it at the output, whereas in the analog connection matrixes this signal reconstruction does not take place, but it is established an actual electric connection between the input and the output by which the analog signal is transmitted. Nevertheless, the analog connection matrixes have a plurality of drawbacks which limit their application.

they use big components which do not allow to be integrated in an integrated circuit, whereby their use in a plurality of electronic applications is limited to a great extent.

they have high internal resistances (for example 100 ohm or 200 ohm when the connection is established, with a variation of for example 20% of said values). More simple devices, such as analog multiplexers, have resistances higher than 1 ohm, and usually higher than 10 ohm

they cannot operate within a high range of frequencies, being only possible to operate at low frequencies (approximately below 10 MHz) or, on the contrary, at high frequencies (over 500 MHz)

they have strong limitations with respect to the range of signal and power of the same. Usually they are limited to signals ranging between −15 V and +15 V, or, in other cases, they can operate with signals until 200 V but they further require a power of 200 V and they have a high internal resistance (more than 25 ohm).

Often the above disadvantages are mutually related, whereby a certain analog connection matrix has several of the above drawbacks simultaneously.

In the present description and claims by analog connection matrix will be understood a device with a plurality of i/o analog contacts (at least four), wherein each of said analog i/o contacts can be either used as input or as output (i.e., there is not a preset directionality in an obligatory fashion in the transmitted signal), and wherein each of at least two of said analog i/o contacts can be connected with at least one of a group of at least two of the other analog i/o contacts in a freely selected way by the user, wherein the established connections can be reversible that is, can be modified. That is, by way of example, provided a matrix with 8 analog i/o contacts (i/o1, i/o2, . . . i/o8), then an analog i/o contact (for example i/o1) must be connectable with at least two of the remainining analog i/o contacts (for example with i/o3 and i/o6: with any of them or with both of them simultaneously) and another analog i/o contact (for example i/o4) must be further connectable with at least two of the remaining analog i/o contacts (for example with i/o7 and i/o8, or with i/o3 and i/o8: with any of them or with both of them simultaneously). It can be observed that in the indicated example i/o3 it is repetead, as i/o3 can be connactable with i/o4 and i/o1 simultaneously. There are a series of devices that cannot be considered matrixes in the sense given in the present invention. Thus, for example, multiplexers have a plurality of inputs and one output, but the inputs are always inputs and they cannot be an output and viceversa. Additionally, the multiplexer allows to connect a certain output (for example n° 4) with the output, or not to connect it, but it cannot connect the input n° 4 with any other input. There is only one contact (output) that can be connected with more than one contact (any of the inputs) and, additionally, always in an alternative way, i.e., it is neither possible to effect a simultaneous connection between two inputs and the output. Analogously, demultiplexers have an input and many outputs, but they are not exchangeable with each other, and it is neither possible to connect each one of the outputs with nothing more than the input. Therefore these devices are not connection matrixes in the sense of the present invention. Likewise there are devices with a plurality of analog i/o contacts which, however, have such an internal wiring structure, that any specific analog i/o contact (for example n° 5) can be connected with another one (for example n° 8) or not. That is, between both contacts there is an electric wiring that can be opened or closed at will. Nevertheless, the only possibility of selection is connecting n° 5 with 8 or leaving it completely disconnected, not being possible to connect contact n° 5 with no other contact of the device. In the sense of the invention, the device is not a connection matrix either, but it is simply an arrangement of independent connections physically fixed in a chip.

### SUMMARY OF THE INVENTION

The objective of the present invention is to overcome the abovementioned drawbacks. This objective is reached by an integrated circuit of the type indicated above characterised in that the connection elements are miniaturised relays, wherein each one of the miniaturised relays comprises a conductive element arranged in the intermediate space, this conductive element being suitable for effecting a movement between a first position and a second position dependant on an electro-magnetic control signal and so opening or closing an electric circuit depending on whether it is in the first position or in the second position.

In fact, by using miniaturised relays several drawbacks can be solved. In the present description and claims by relay will be understood a device wherein an electric circuit is closed by a physical contact of a conductive element with two points of the electric circuit,and wherein the circuit is opened by a physical separation of the conductive element of at least one of the points of the electric circuit.

The use of miniaturised relays allows to operate in a higher range of frequencies. Preferably the analog connection matrix is suitable for switching signals that are within a range of frequencies between 0 and up to 1 GHz, and more preferably between 0 and more than 10 GHz.

Furthermore, lower internal resistances can be reached, as preferably the miniaturised relay has a contact resistance lower than 100 miliohms and more preferably lower than 10 miliohms.

Additionally, the use of miniaturised relays allows the analog connection matrix to operate with voltage and power ranges much higher than the ones possible by means of solid state devices or, al least, in a much cheaper way.

Advantageously, each miniaturised relay has its larger dimensions (preferably miniaturised relays are substantially plane, with one dimension, the thickness, much lower than the length and the width) lower than 500 micron×500 micron, and preferably lower than 100 micron×100 micron. That allows including more than 1000 relays in a printed circuit of approximately 1 cm², which would be enough to form a matrix of 32 analog i/o contacts completely interconnected with one another, as it will be now described.

The way of obtaining a miniaturised relay allowing its integration in an integrated circuit will be now explained.

An integrated circuit as the one of the present invention allows a design of printed circuits much more simplified, due to the fact that the interconnection between the different discrete elements of a printed circuit can be achieved in a simple way, by simply arranging the elements about the integrated circuit and fixing them with the integrated circuit. Subsequently, a suitable programming allows to establish the connections among the elements of interest. Furthermore, any adjustment, correction or change of design can be made in a more simple manner. It is even possible to include in the printed circuit some redundant elements or of similar values, with the aim to finally use only one of them. The other one will keep connected to the integrated circuit, but the analog matrix will not connect it to any other element of the electric circuit.

Another advantage is that it allows a checking of all the electric connections as, in fact, all the analog i/o contacts can be accessed.

Another additional advantage is the possibility of adjusting filters, amplifiers and other systems in a digitilized form, because a series of values for a specific analog component can be included, and any of them can be connected in each moment (one or a plurality of them), so that that (or those) will be always connected with which the best result is obtained. For example, through 10 condensers, suitable for being connected or not by means of an integrated circuit according to the invention, it is possible to reach an accuracy of tuning of 10 bits.

These advantages allow to reduce the number of layers of the printed circuit to be used, as well as its surface area, with the consequent savings in costs, size and weight.

Advantageously, the integrated circuit according to the invention at least comprises a second analog connection matrix having a plurality of second analog i/o contacts, which have a plurality of interconnections which are electric with respect to one another through second connection elements, being these second connection elements miniaturised relays, wherein each of the miniaturised relays comprises a conductive element arranged in the intermediate space, this conductive element being suitable for performing a movement between a first position and a second position dependant on an electromagnetic control signal and which opens or closes an electric circuit depending on whether it is in the first position or in the second position, wherein a plurality of analog i/o contacts are electrically connected to a plurality of second analog i/o contacts.

Indeed, if it is wished to have a high amount of analog i/o contacts, it is possible to develop a single analog connection matrix that establishes the connections between the different analog i/o contacts in a direct manner. However, advantageously a plurality of analog connection matrixes (2 or more) mutually interconnected is provided. For the end user, the assembly (in final integrated circuit) seems to be the single analog connection matrix, but the use of a plurality of analog connection matrixes, each one of less amount of analog i/o contacts, allows to diminish the amount of necessary relays, mantaining high the level of interconnectability.

From the point of view of versatility, preferably each of the analog i/o contacts has an electric interconnection with all and each of the remaining analog i/o contacts. In this manner, the interconnectability is complete as well as the flexibility and versatility. For the same reason, in case of having more than one analog connection matrix is also advantageous that each of the second analog i/o contacts has an electric interconnection with all and each of the remaining second analog i/o contacts. Nevertheless, the complete interconnectability can imply the need of including a high amount of relays, and it can be advisable to sacrify a certain degree of interconnectability in exchange for less complexity and/or the possibility of being able to have a greater amount analog i/o contacts. In this respect, it can be advantageous that at least one of the analog i/o contacts lacks an electric interconnection with at least one of the remaining analog i/o contacts.

The analog connection matrix requires to receive a series of control signals, that will be the ones that will establish in an specific manner the connections among the different analog i/o contacts, opening or closing the corresponding relays. These signals are preferably generated by a control circuit of miniaturised relays included in the analog connection matrix or, at least, in the integrated circuit. In this case, the integrated circuit will be also provided with control i/o contacts, by which the control circuit will be programmed, controlled and supplied.

Preferably each of the electric interconnections is formed by only one miniaturised relay. However, it can be advisable, especially in the case of complex analog connection matrixes, to include internal interconnection nodes so that some of the electric interconnections is formed by more than one miniaturised relay and by at least one internal interconnection node. The increase of complexity that imply the electric interconnections of this type is, however, compensated by the reduction of complexity of the analog connection matrix as a whole.

Furthermore, the object of the invention is a “universal” circuit or analog programmable circuit. Indeed, thanks to the use of an analog connection matrix as the ones described above, it is possible to design a circuit having several electric passive elements (as preferably resistors, coils and/or condensers) and/or active elements (as preferably amplifiers, transistors, diodes and/or other semi-conductive devices), as well as combinations thereof, being also possible to have electric elements of the same type but with different values, and all of them connected to the analog connection matrix. By simply using a suitable programming of the analog connection matrix it can be achieved to transform this “universal” circuit in any specific circuit that performs a certain electric or electronic function. Moreover the use of a “universal” circuit of this type allows to make fast changes of designs, improvements or adjustments on the preceding designs, or corrections of mistakes, all this by simply reprogramming the analog connection matrix. This can be particularly advantageous in multiple cases, due to the fact that it allows to accelerate the design steps and, for example, it could be particularly useful if a failure of design is detected when a certain product is already in the production step. Actually, in this case the problem can be solved by simply reprogramming the analog connection matrix, not being necessary to make any modification in the physical elements that are mounted in the production line. Preferably, the “universal” circuit is a printed circuit at least comprising an integrated circuit with an analog connection matrix according to the invention and a plurality of active and/or passive electric elements electrically connected to said analog connection matrix. On the other hand, as it has been previously said, it is possible to introduce certain electric elements, either active or passive, in the interior of integrated circuits. Thus, the “universal” circuit can be preferably an integrated circuit at least comprising an analog connection matrix according to the invention and a plurality of active and/or passive electric elements electrically connected to said analog connection matrix. Logically both concepts can be combined, i.e., an integrated circuit that defines a “universal” circuit can be installed in a printed circuit, so that the assembly defines another “universal” circuit. On the other hand, it is also advantageous a printed circuit and/or an integrated circuit as the above mentioned comprising a digital programmable circuit.

Currently there are various alternatives for the production of miniaturised relays, in particular, in the context of technologies known as MEMS technology (micro electro-mechanical systems), Microsystems and/or Micromachines. In principal such may be classified according to the type of force or actuation mechanism they use to move the contact electrode. The classification usually applied is thus between electrostatic, magnetic, thermal and piezoelectric relays. Each one has its advantages and its drawbacks. However miniaturisation techniques require the use of activation voltages and surface areas which are as small as possible. Relays known in the state of the art have several problems impeding their advance in this respect.

A manner of reducing the activation voltage is precisely to increase the relay surface areas, which renders miniaturisation difficult, apart from being conducive to the appearance of deformations reducing the useful life and reliability of the relay. In electrostatic relays, another solution for decreasing the activation voltage is to greatly reduce the space between the electrodes, or use very thin electrodes or special materials, so that the mechanical recovery force is very low. However this implies problems of sticking, since capillary forces are very high, which thus also reduces the useful working life and reliability of these relays. The use of high activation voltages also has negative effects such as ionisation of the components, accelerated wearing due to strong mechanical solicitation and the electric noise which the relay generates.

Electrostatic relays also have a significant problem as to reliability, due to the phenomenon known as “pull-in”, and which consists in that, once a given threshold has been passed, the contact electrode moves in increasing acceleration against the other free electrode. This is due to the fact that as the relay closes, the condenser which exerts the electrostatic force for closing, greatly increases its capacity (and would increase to infinity if a stop were not imposed beforehand). Consequently there is a significant wear on the electrodes due to the high electric field which is generated and the impact caused by the acceleration to which the moving electrode has been exposed.

Thermal, magnetic and piezoelectric approaches require special materials and micromachining processes, and thus integration in more complex MEMS devices, or in a same integrated with electronic circuitry is difficult and/or costly. Additionally the thermal approach is very slow (which is to say that the circuit has a long opening or closing time) and uses a great deal of power. The magnetic approach generates electromagnetic noise, which renders having close electronic circuitry much more difficult, and requires high peak currents for switching.

In this specification relay should be understood to be any device suitable for opening and closing at least one external electric circuit, in which at least one of the external electric circuit opening and closing actions is performed by means of an electromagnetic signal.

In the present description and claims the expression “contact point” has been used to refer to contact surfaces in which an electric contact is made (or can be made). In this respect they should not be understood as points in the geometric sense, since they are three-dimensional elements, but rather in the electric sense, as points in an electric circuit.

For all this, in the integrated circuit according to the invention the miniaturised relay comprises:

a first zone facing a second zone,

a first condenser plate,

a second condenser plate arranged in the second zone, in which the second plate is smaller than or equal to the first plate,

an intermediate space arranged between the first zone and the second zone,

a conductive element arranged in the intermediate space, the conductive element being mechanically independent of the first zone and the second zone and being suitable for performing a movement across the intermediate space dependant on voltages present in the first and second condenser plates,

a first contact point of an electric circuit, a second contact point of the electric circuit, in which the first and second contact point define first stops, in which the conductive element is suitable for entering into contact with the first stops and in which the conductive element closes the electric circuit when in contact with the first stops.

In fact in the relay according to the invention the conductive element, which is to say the element responsible for opening and closing the external electric circuit (across the first contact point and the second contact point), is a detached part capable of moving freely. i.e. the elastic force of the material is not being used to force one of the relay movements. This allows a plurality of different solutions, all benefiting from the advantage of needing very low activation voltages and allowing very small design sizes. The conductive element is housed in the intermediate space. The intermediate space is closed by the first and second zone and by lateral walls which prevent the conductive element from leaving the intermediate space. When voltage is applied to the first and second condenser plate charge distributions are induced in the conductive element which generates electrostatic forces which in turn move the conductive element in a direction along the intermediate space. By means of different designs to be described in detail below this effect can be used in several different ways.

Additionally, a relay according to the invention likewise satisfactorily resolves the previously mentioned problem of “pull-in”.

Another additional advantage of the relay according to the invention is the following: in conventional electrostatic relays, if the conductive element sticks in a given position (which depends to a great extent, among other factors, on the humidity) there is no possible manner of unsticking it (except by external means, such as for example drying it) since due to the fact that the recovery force is elastic, is always the same (depending only on the position) and cannot be increased. On the contrary, if the conductive element sticks in a relay according to the invention, it will always be possible to unstick it by increasing the voltage.

The function of the geometry of the intermediate space and the positioning of the condenser plates can furnish several different types of relays, with as many applications and functioning methods

For example, the movement of the conductive element can be as follows:

a first possibility is that the conductive element moves along the intermediate space with a travelling movement, i.e., in a substantially rectilinear manner (excluding of course possible impacts or oscillations and/or movements provoked by unplanned and undesired external forces) between the first and second zones.

a second possibility is that the conductive element have a substantially fixed end, around which can rotate the conductive element. The rotational axis can serve the function of contact point for the external electric circuit and the free end of the conductive element can move between the first and second zones and make, or not make, contact with the other contact point, depending on its position. As will be outlined below, this approach has a range of specific advantages.

Advantageously the first contact point is between the second zone and the conductive element. This allows a range of solutions to be obtained, discussed below. A preferable embodiment is achieved when the first plate is in the second zone. Alternatively the relay can be designed so that the first plate is in the first zone. In the first case a relay is obtained which has a greater activation voltage and which is faster. On the other hand, in the second case the relay is slower, which means that the shocks experienced by the conductive element and the stops are smoother, and energy consumption is lower. One can obviously choose between one or the other alternatives depending on the specific requirements in each case.

A preferable embodiment of the invention is obtained when the second contact point is likewise in the second zone. In this case one will have a relay in which the conductive element performs the substantially rectilinear travelling movement. When the conductive element is in contact with the first stops, which is to say with the first and second contact point of the electric circuit, the electric circuit is closed, and it is possible to open the electric circuit by means of different types of forces, detailed below. To again close the electric circuit, it is enough to apply voltage between the first and second condenser plates. This causes the conductive element to be attracted toward the second zone, again contacting the first and second contact point.

Should the first condenser plate be in the first zone and the second condenser plate in the second zone, a manner of achieving the necessary force to open the circuit cited in the above paragraph is by means of the addition of a third condenser plate arranged in the second zone, in which the third condenser plate is smaller than or equal to the first condenser plate, and in which the second and third condenser plates are, together, larger than the first condenser plate. With this arrangement the first condenser plate is to one side of the intermediate space and the secorid and third condenser plates are to the other side of the intermediate space and close to one another. In this manner one can force the movement of the conductive element in both directions by means of electrostatic forces and, in addition, one can guarantee the closing of the external electric circuit even though the conductor element remains at a voltage in principle unknown, which will be forced by the external circuit that is closed.

Another preferable embodiment of the invention is achieved when the relay additionally comprises a third condenser plate arranged in said second zone and a fourth condenser plate arranged in said first zone, in which said first condenser plate and said second condenser plate are equal to each other, and said third condenser plate and said fourth condenser plate are equal to one another. In fact, in this manner, if one wishes the conductive element to travel towards the second zone, one can apply voltage to the first and fourth condenser plates, on one side, and to the second or to the third condenser plates, on the other side. Given that the conductive element will move toward the place in which is located the smallest condenser plate, it will move toward the second zone. Likewise one can obtain movement of the conductive element toward the first zone by applying a voltage to the second and third condenser plates and to the first or the fourth condenser plates. The advantage of this solution, over the simpler three condenser plate solution, is that it is totally symmetrical, which is to say that it achieves exactly the same relay behaviour irrespective of whether the conductive element moves toward the second zone or the first zone. Advantageously the first, second, third and fourth condenser plates are all equal with respect to one another, since generally it is convenient that in its design the relay be symmetrical in several respects. On one hand there is symmetry between the first and second zone, as commented above. On the other hand it is necessary to retain other types of symmetry to avoid other problems, such as for example the problems of rotation or swinging in the conductive element and which will be commented upon below. In this respect it is particularly advantageous that the relay comprises, additionally, a fifth condenser plate arranged in the first zone and a sixth condenser plate arranged in the second zone, in which the fifth condenser plate and the sixth condenser plate are equal to each other. On one hand increasing the number of condenser plates has the advantage of better compensating manufacturing variations. On the other, the several different plates can be activated independently, both from the point of view of voltage applied as of activation time. The six condenser plates can all be equal to each other, or alternatively the three plates of a same side can have different sizes with respect to one another. This allows minimising activation voltages. A relay which has three or more condenser plates in each zone allows the following objectives to all be achieved:

it can function in both directions symmetrically,

it has a design which allows a minimum activation voltage for fixed overall relay dimensions, since by having two plates active in one zone and one plate active in the other zone distinct surface areas can always be provided,

it allows minimisation of current and power consumption, and also a smoother relay functioning,

it can guarantee the opening and closing of the relay, independently of the voltage transmitted by the external electric circuit to the conductive element when they enter in contact,

in particular if the relay has six condenser plates in each zone, it can in addition comply with the requirement of central symmetry which, as we shall see below, is another significant advantage. Therefore another preferable embodiment of the invention is obtained when the relay comprises six condenser plates arranged in the first zone and six condenser plates arranged in the second zone. However it is not absolutely necessary to have six condenser plates in each zone to achieve central symmetry: it is possible to achieve it as well, for example, with three condenser plates in each zone, although in this case one must forego minimising current and power consumption and optimising the “smooth” functioning of the relay. In general, increasing the number of condenser plates in each zone allows greater flexibility and versatility in the design, whilst it allows a reduction of the variations inherent in manufacture, since the manufacturing variations of each of the plates will tend to be compensated by the variations of the remaining plates.

However it should not be discounted that in certain cases it can be interesting to deliberately provoke the existence of force moments in order to force the conductive element to perform some kind of revolution additional to the travelling movement. It could be advantageous, for example, to overcome possible sticking or friction of the conductive element with respect to the fixed walls.

Advantageously the relay comprises a second stop (or as many second stops as there are first stops) between the first zone and the conductive element. In this manner one also achieves a geometric symmetry between the first zone and the second zone. When the conductive element moves toward the second zone, it can do so until entering into contact with the first stops, and will close the external electric circuit. When the conductive element moves toward the first zone it can do so until entering into contact with the second stop(s). In this manner the movement performed by the conductive element is symmetrical.

Another preferable embodiment of the invention is achieved when the relay comprises a third contact point arranged between the first zone and the conductive element, in which the third contact point defines a second stop, such that the conductive element closes a second electric circuit when in contact with the second contact point and third contact point. In this case the relay acts as a commuter, alternately connecting the second contact point with the first contact point and with the third contact point.

A particularly advantageous embodiment of the previous example is achieved when the conductive element comprises a hollow cylindrical part which defines a axis, in the interior of which is housed the second contact point, and a flat part which protrudes from one side of the radially hollow cylindrical part and which extends in the direction of the axis, in which the flat part has a height, measured in the direction of the axis, which is less than the height of the cylindrical part, measured in the direction of the axis. This specific case complies simultaneously with the circumstance that the conductive element perform a rotational movement around one of its ends (cf. the “second possibility” cited above). Additionally, the cylindrical part is that which rests on bearing surfaces (one at each end of the cylinder, and which extends between the first zone and the second zone) whilst the flat part is cantilevered with respect to the cylindrical part, since it has a lesser height. Thus the flat part is not in contact with walls or fixed surfaces (except the first and third contact point) and, in this manner, the sticking and frictional forces are lessened. As to the second point of contact, it is housed in the internal part of the cylindrical part, and serves as rotational axis as well as second contact point. Thus an electric connection is established between the first and second contact points or between the third and second contact points. The hollow cylindrical part defines a cylindrical hollow, which in all cases has a surface curved to the second contact point, thus reducing the risks of sticking and frictional forces.

Another particularly advantageous embodiment of the previous example is obtained when the conductive element comprises a hollow parallelepipedic part which defines a axis, in the interior of which is housed the second contact point, and a flat part which protrudes from one side of the radially hollow paralelepipedic part and which extends in the direction of the axis, in which the flat part has a height, measured in the direction of the axis, which is less than the height of the parallelepipedic part, measured in the direction of the axis. In fact, it is an embodiment similar to that above, in which the parallelepipedic part defines a parallelepipedic hollow. This solution can be particularly advantageous in the case of very small embodiments, since in this case the resolution capacity of the manufacturing process (in particular in the case of the photolithographic procedures) obliges the use of straight lines. In both cases it should be emphasised that the determining geometry is the geometry of the interior hollow and that, in fact, several different combinations are possible:

axis (second contact point) having a rectangular section and hollow with rectangular section,

axis having a circular section and hollow having a circular section,

axis having a circular section and hollow having a rectangular section and vice versa,

although the first two combinations are the most advantageous.

Logically, should the sections be rectangular, there should be enough play between the axis and the parallelepipedic part such that the conductive element can rotate around the axis. Likewise in the case of circular sections there can be a significant amount of play between the axis and the cylindrical part, such that the real movement performed by the conductive element is a combination of rotation around the axis and travel between the first and second zone. It should be noted, additionally, that it is also possible that the second stop not be connected electrically to any electric circuit: in this case a relay will be obtained which can open and close only one electric circuit, but in which the conductive element moves by means of a rotation (or by means of a rotation combined with travel).

Another preferable embodiment of the invention is obtained when the relay comprises a third and a fourth contact points arranged between the first zone and the conductive element, in which the third and fourth contact points define second stops, such that the conductive element closes a second electric circuit when in contact with the third and fourth contact points. In fact, in this case the relay can alternatively connect two electric circuits.

Advantageously each of the assemblies of condenser plates arranged in each of the first zone and second zone is centrally symmetrical with respect to a center of symmetry, in which said center of symmetry is superposed to the center of masses of the conductive element. In fact, each assembly of the condenser plates arranged in each of the zones generates a field of forces on the conductive element. If the force resulting from this field of forces has a non nil moment with respect to the center of masses of the conductive element, the conductive element will not only undergo travel but will also undergo rotation around its center of masses. In this respect it is suitable to provide that the assemblies of plates of each zone have central symmetry in the case that this rotation is not advantageous, or on the other hand it could be convenient to provide central asymmetry should it be advantageous to induce rotation in the conductive element with respect to its center of masses, for example to overcome frictional forces and/or sticking.

As already indicated, the conductive element is usually physically enclosed in the intermediate space, between the first zone, the second zone and lateral walls. Advantageously between the lateral walls and the conductive element there is play sufficiently small such as to geometrically prevent the conductive element entering into contact simultaneously with a contact point of the group formed by the first and second contact points and with a contact point of the group formed by the third and fourth contact points. That is to say, the conductive element is prevented from adopting a transversal position in the intermediate space in which it connects the first electric circuit to the second electric circuit.

To avoid sticking and high frictional forces it is advantageous that the conductive element has rounded external surfaces, preferably that it be cylindrical or spherical.

The spherical solution minimises the frictional forces and sticking in all directions, whilst the cylindrical solution, with the bases of the cylinder facing the first and second zone allow reduced frictional forces to be achieved with respect to the lateral walls whilst having large surfaces facing the condenser plates—efficient as concerns generation of electrostatic forces. It also has larger contact surfaces with the contact points, diminishing the electric resistance which is introduced in the commuted electric circuit.

Likewise, should the conductive element has an upper face and a lower face, which are perpendicular to the movement of the conductive element, and at least one lateral face, it is advantageous that the lateral face has slight protuberances. These protuberances will further allow reduction of sticking and frictional forces between the lateral face and the lateral walls of the intermediate space.

Advantageously the conductive element is hollow. This allows reduced mass and thus achieves lower inertia.

Should the relay have two condenser plates (the first plate and the second plate) and both in the second zone, it is advantageous that the first condenser plate and the second condenser plate have the same surface area, since in this manner the minimal activation voltage is obtained for a same total device surface area.

Should the relay have two condenser plates (the first plate and the second plate) and the first plate is in the first zone whilst the second plate is in the second zone, it is advantageous that the first condenser plate has a surface area that is equal to double the surface area of the second condenser plate, since in this manner the minimal activation voltage is obtained for a same total device surface area.

Another preferable embodiment of a relay according to the invention is obtained when one of the condenser plates simultaneously serves as condenser plate and as contact point (and thus of stop). This arrangement will allow connection of the other contact point (that of the external electric circuit) at a fixed voltage (normally VCC or GND) or leaving it at high impedance.

### BRIEF DESCRIPTION OF THE DRAWINGS

Other advantages and characteristics of the invention will become evident from the following description in which, entirely non-limitatively, are described some preferential embodiments of the invention, with reference to the appended drawings. The figures show:

FIG. 1, a diagram of an analog connection matrix of n analog i/o contacts.

FIG. 2, a diagram of triangular interconnection.

FIG. 3, a diagram of a square interconnection.

FIG. 4, a diagram of hexagonal interconnection.

FIGS. 5 to 8, diagrams of interconnection of analog connection matrixes.

FIG. 9, a simplified diagram of a relay with two condenser plates in the second zone thereof.

FIG. 10, a simplified diagram of a relay with two condenser plates, one in each of the zones thereof.

FIG. 11, a simplified diagram of a relay with three condenser plates.

FIG. 12, a perspective view of a first embodiment of a relay according to the invention, uncovered.

FIG. 13, a plan view of the relay of FIG. 12.

FIG. 14, a perspective view of a second embodiment of a relay according to the invention.

FIG. 15, a perspective view of the relay of FIG. 14 from which the components of the upper end have been removed.

FIG. 16, a perspective view of the lower elements of the relay of FIG. 14.

FIG. 17, a perspective view of a third embodiment of a relay according to the invention, uncovered.

FIG. 18, a perspective view, in detail, of the cylindrical part of the relay of FIG. 17.

FIG. 19, a perspective view of a fourth embodiment of a relay according to the invention.

FIG. 20, a perspective view of a fifth embodiment of a relay according to the invention.

FIG. 21, a plan view of a sixth embodiment of a relay according to the invention.

FIG. 22, a perspective view of a seventh embodiment of a relay according to the invention.

FIG. 23, a perspective view from below, without substrate, of an eighth embodiment of a relay according to the invention.

FIG. 24, a sphere produced with surface micromachining.

FIG. 25, a plan view, uncovered, of a ninth embodiment of a relay according to the invention.

As shall be seen below, the preferred embodiments of the invention illustrated in the figures include a combination of the several different alternatives and options considered above, whilst a person skilled in the art will be able to see what alternatives and options can be combined together in different ways.

### DETAILED DESCRIPTION OF SOME EMBODIMENTS OF THE INVENTION

Internally the matrix of analog connection is basically an assembly of miniaturised relays mutually interconnected and connected with the analog i/o contacts. A control digital circuitry is responsible for controlling the relays, forcing that each of them is in the corresponding open or closed position, according to a specific programming. As it has been previously mentioned the control circuit is preferably in the same integrated circuit, and, whereby the integrated circuit will have control i/o contacts for programming, controlling and the power supply of the control circuit.

The control circuit can be, for example, an ASIC or a PLD (Programmable Logic Device), that will form a second silicon block in the integrated circuit, next to the silicon block that will form the miniaturised relays. The control circuit has one or more connections for each relay, that will be controlled by signals of as maximum 5V. In case of using a manufacture method for miniaturised relays that would be compatible with the CMOS technology or another technology that allows to make the control digital circuitry, then it can be included in a same silicon block both the miniaturised relays and the control circuit.

The analog connection matrix can have a complete interconnectability, i.e., that any analog i/o contact can be connected with any other analog i/o contact, or it can have a partial interconnectability more or less complete depending on the design. The complete interconnectability causes that the complexity of the design increases in a great manner as the amount of analog i/o contacts increases. That obliges to use a high amount of layers, and that has technological limitations, either reducing the resolution process or increasing the used silicon surface area. Thus the use of analog connection matrixes with partial interconnectabilities but in any case high, can be a good commitment between the cost of design and manufacture and the performances given to the user.

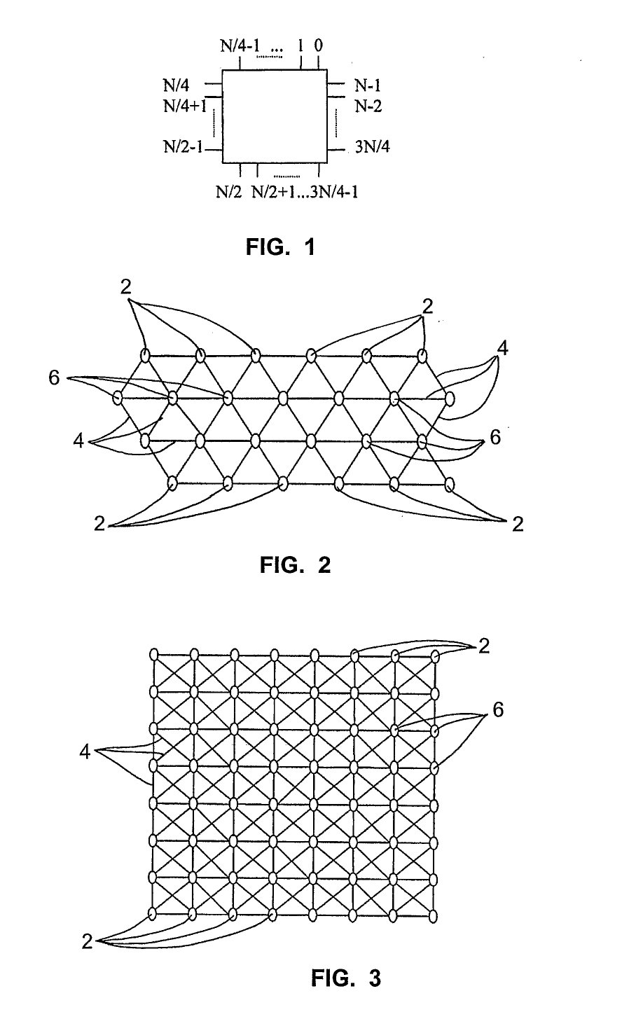

An example of analog connection matrix can be observed in FIG. 1. In case that a complete interconnection is wished, it would be required a minimum M amount of internal relays equal to N(N−1)/2, that is approximately equal to N²/2, specially for high N values. Indeed in order to assure a complete interconnection it is necessary to establish interconnections between each analog i/o contact with all the others.

FIG. 2 shows an example of interconnection between analog i/o contacts 2, wherein each interconnection 4 is represented by a line between two circles. Each interconnection 4 corresponds to a relay. In FIG. 2 the upper and lower row of circles represent, for example, the analog i/o contacts 2, whilst the intermediate circles would represent an internal node 6 of interconnection. As it can be observed in this case the interconnection could not be complete, but it could be widened by successive interconnection layers.

In FIG. 3 an example of an interconnection structure can be observed. While in FIG. 2 the basic structure is triangular, in the structure 3 the basic structure is squared, with diagonals. In this case it is already required a minimum of two levels of layers, as the diagonals of each square must be at a different level. This structure allows a greater level of interconnectability for a same level of internal nodes 6 of interconnection.

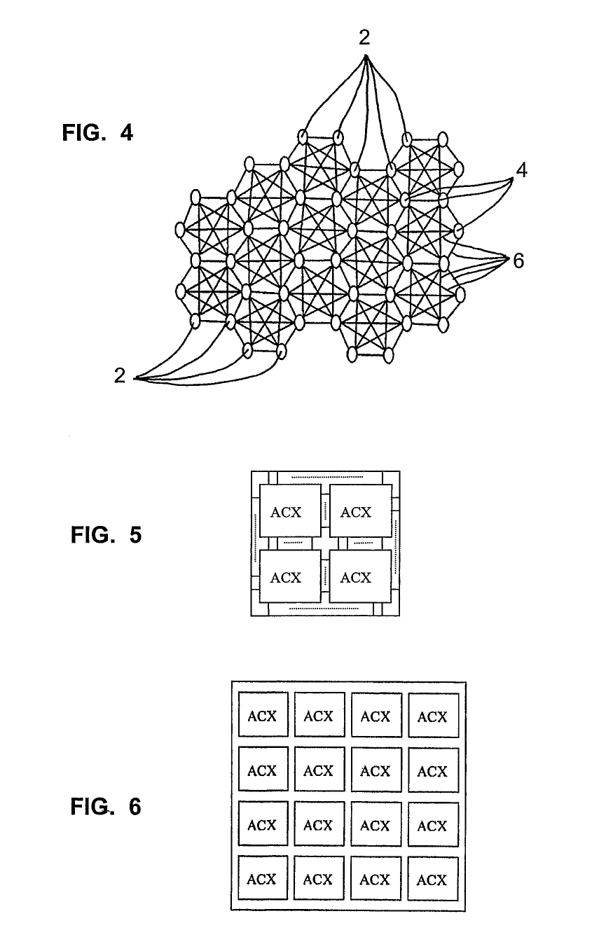

A further example of interconnection is shown in FIG. 4, wherein the basic unit is an hexagon with intermediate interconnections among all the non-adjacent corners. In a similar manner to the previous case, the increase of complexity, for example due to requiring a greater number of levels, means however a greater interconnectability for a same number of internal nodes 6 of interconnection.

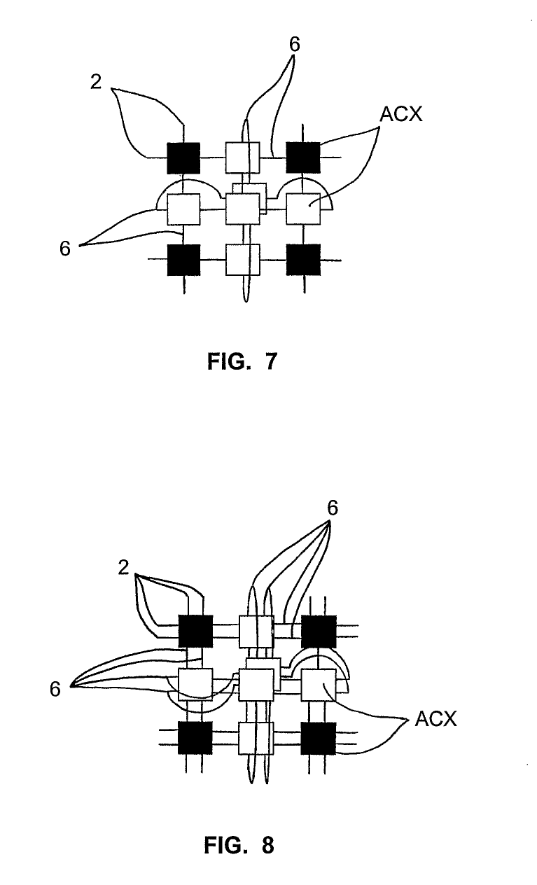

FIG. 5 shows an example of combination of four ACX analog connection matrixes in order to form a greater analog connection matrix without increasing the complexitiy above an specific value. Each of the ACX analog connection matrixes can be of complete or partial interconnectability. The interconnectability of the assembly will be defined by the interconnectability of each of the matrixes and by the interconnectability between the matrixes, in case that the interconnectability with respect to one another is not complete (the possible interconnections have been represented by dotted lines in FIG. 5). In FIG. 6 a further example wherein 4×4 ACX analog connection matrixes (the interconnections have not been represented) can be observed.

In case that each of the ACX analog connection matrixes is of complete interconnection, and the assembly is wished to be of complete interconnection, then it is required to have more ACX analog connection matrixes arranged in other levels. An example is shown in FIG. 7 wherein by means of ten ACX analog connection matrixes of four analog i/o contacts 2 with complete interconnection an analog connection matrix of eight analog i/o contacts 2 can be obtained. A further example is shown in FIG. 8 wherein by means of ten ACX analog connection matrixes of eight analog i/o contacts 2 with complete interconnection an analog connection matrix of sixteen analog i/o contacts 2 with complete interconnection is obtained.

In the case of a simple analog connection matrix with 16 analog i/o contacts 2 and complete interconnectability, it is necessary a minimum of 120 internal interconnections and in the case of 32 analog i/o contacts 2 with complete interconnectability a minimum of 496 internal interconnections is required. These solutions can be included in an integrated circuit of 1 cm×1 cm, taking into account that a relay according to the invention can be of 300 micron×300 micron, designed to be manufactured with polyMUMPS technology (with a resolution of 5 microns). With other technologies, such as for example SUMMIT (with a resolution of 1 micron) it could be obtained more reduced sizes or more complex matrixes for a same size.

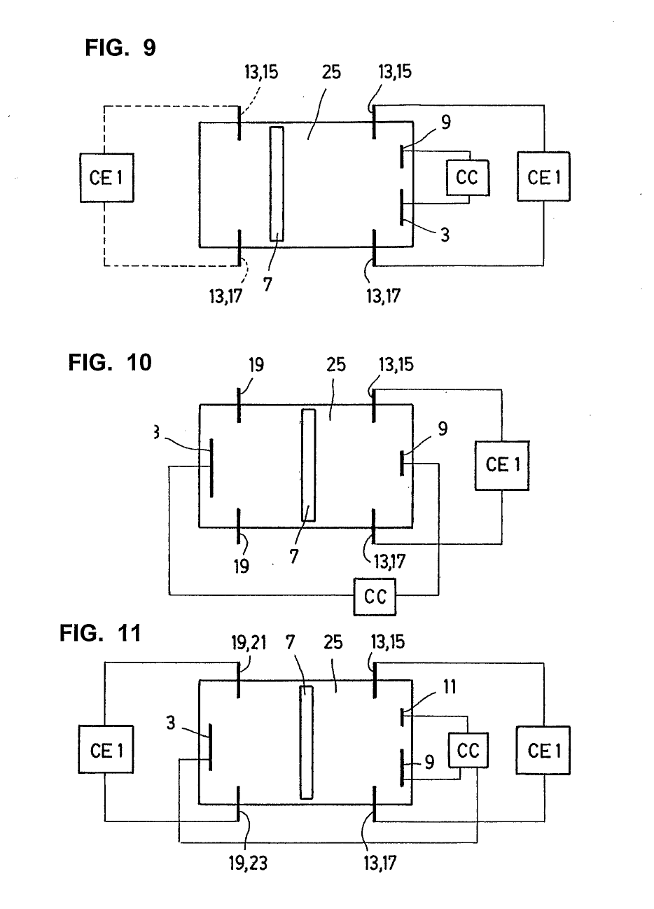

FIG. 9 shows a first basic functioning mode of a relay according to the invention. The relay defines an intermediate space 25 in which is housed a conductive element 7, which can move freely along the intermediate space 25, since physically it is a detached part which is not physically joined to the walls which define the intermediate space 25. The relay also defines a first zone, on the left in FIG. 9, and a second zone, on the right in FIG. 9. In the second zone are arranged a first condenser plate 3 and a second condenser plate 9. In the example shown in FIG. 9 both condenser plates 3 and 9 have different surface areas, although they could be equal with respect to one another. The first condenser plate 3 and the second condenser plate 9 are connected to a CC control circuit. Applying a voltage between the first condenser plate 3 and the second condenser plate 9, the conductive element is always attracted towards the right in FIG. 9, towards the condenser plates 3 and 9. The conductive element 7 will be moved towards the right until being stopped by first stops 13, which are a first contact point 15 and a second contact point 17 of a first external electric circuit CE1, such that the first external electric circuit CE1 is closed.

FIG. 10 shows a second basic functioning mode for a relay according to the invention. The relay again defines an intermediate space 25 in which is housed a conductive element 7, which can move freely along the intermediate space 25, a first zone, on the left in FIG. 10, and a second zone, on the right in FIG. 10. In the second zone is arranged a second condenser plate 9 whilst in the first zone is arranged a first condenser plate 3. The first condenser plate 3 and the second condenser plate 9 are connected to a CC control circuit. Applying a voltage between the first condenser plate 3 and the second condenser plate 9, the conductive element is always attracted to the right of the FIG. 10, towards the smallest condenser plate, i.e. towards the second condenser plate 9. For this reason, the fact that in the example shown in FIG. 10 both condenser plates 3 and 9 have different surface areas is, in this case, absolutely necessary, since if they were to have equal surface areas, the conductive element 7 would not move in any direction. The conductive element 7 will move towards the right until being stopped by first stops 13, which are a first contact point 15 and a second contact point 17 of a first external electric circuit CE1, such that the first external electric circuit CE1 is closed. On the left there are second stops 19 which in this case do not serve any electric function but which stop the conductive element 7 from entering into contact with the first condenser plate 3. In this case the stops 19 can be removed, since no problem is posed by the conductive element 7 entering into contact with the first condenser plate 3. This is because there is only one condenser plate on this side, if there had been more than one and if they had been connected to different voltages then the stops would have been necessary to avoid a short-circuit.

To achieve moving the conductive element 7 in both directions by means of electrostatic forces, it is necessary to provide a third condenser plate 11, as shown in FIG. 11. Given that the conductive element 7 will always move towards where the smallest condenser plate is located, it is necessary, in this case, that the third condenser plate 11 be smaller than the first condenser plate 3, but that the sum of the surface areas of the second condenser plate 9 and the third condenser plate 11 be larger than the first condenser plate 3. In this manner, activating the first condenser plate 3 and the second condenser plate 9, connecting them to different voltages, but not the third condenser plate 11, which will remain in a state of high impedance, the conductive element 7 can be moved to the right, whilst activating the three condenser plates 3, 9 and 11 the conductor element 7 can be moved to the left. In the latter case the second condenser plate 9 and the third condenser plate 11 are supplied at a same voltage, and the first condenser plate 3 at a different voltage. The relay of FIG. 11 has, in addition, a second external electric circuit CE2 connected to the second stops 19, in a manner that these second stops 19 define a third contact point 21 and a fourth contact point 23

Should two condenser plates be provided in each of the first and second zones, the movement of the conductive element 7 can be solicited in two different ways:

applying a voltage between the two condenser plates of a same zone, so that the conductive element is attracted by them (functioning as in FIG. 9)

applying a voltage between one condenser plate of one zone and a (or both) condenser plate(s) of the other zone, such that the conductive element 7 is attracted towards the zone in which the electrically charged condenser surface area is smallest (functioning as in FIG. 10).

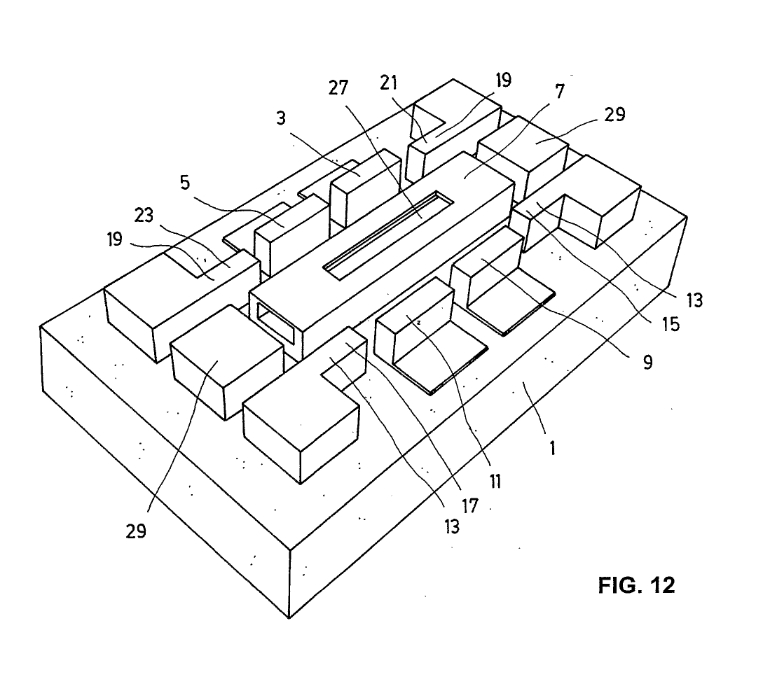

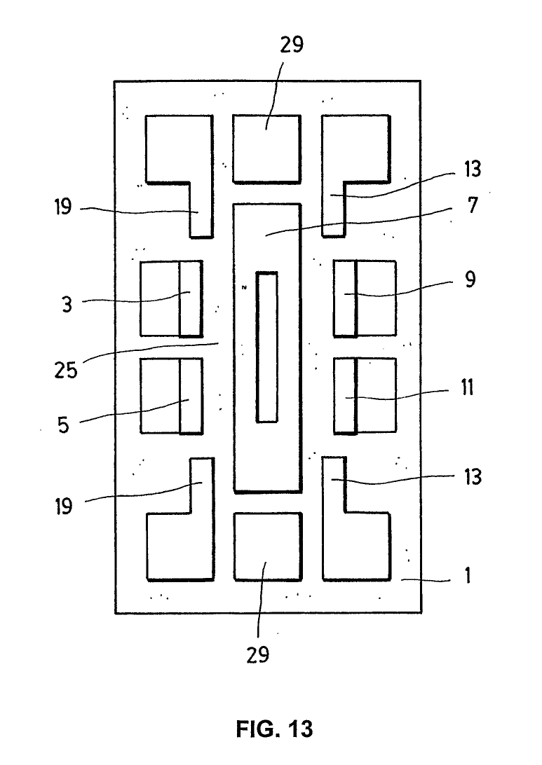

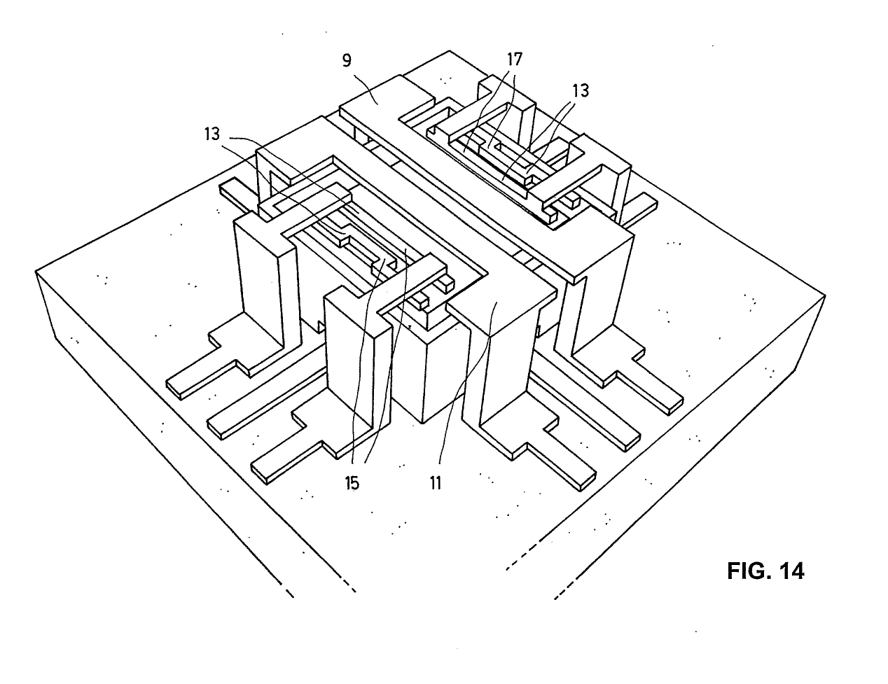

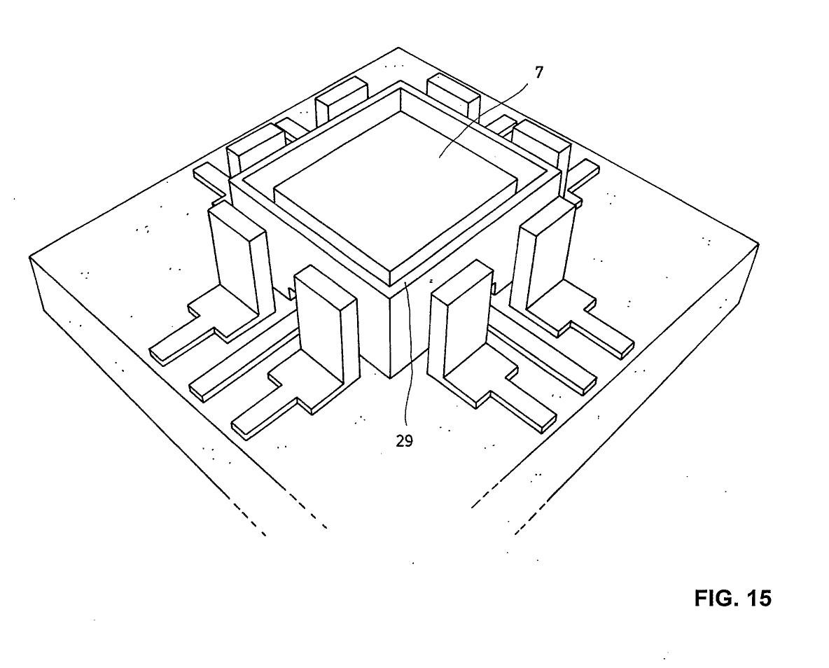

FIGS. 12 and 13 illustrate a relay designed to be manufactured with EFAB technology. This micromechanism manufacturing technology by means of layer depositing is known by persons skilled in the art, and allows the production of several layers and presents a great deal of versatility in the design of three-dimensional structures. The relay is mounted on a substrate 1 which serves as support, and which in several Figures has not been illustrated in the interest of simplicity. The relay has a first condenser plate 3 and a fourth condenser plate 5 arranged on the left (according to FIG. 13) of a conductive element 7, and a second condenser plate 9 and a third condenser plate 11 arranged on the right of the conductive element 7. The relay also has two first stops 13 which are the first contact point 15 and the second contact point 17, and two second stops 19 which are the third contact point 21 and the fourth contact point 23. The relay is covered in its upper part, although this cover has not been shown in order to be able to clearly note the interior details.

The relay goes from left to right, and vice versa, according to FIG. 13, along the intermediate space 25. As can be observed the first stops 13 and the second stops 19 are closer to the conductive element 7 than the condenser plates 3, 5, 9 and 11. In this manner the conductive element 7 can move from left to right, closing the corresponding electric circuits, without interfering with the condenser plates 3, 5, 9 and 11, and their corresponding control circuits.

The conductive element 7 has a hollow internal space 27.

There is play between the conductive element 7 and the walls which form the intermediate space 25 (which is to say the first stops 13, the second stops 19, the condenser plates 3, 5, 9 and 11 and the two lateral walls 29) which is sufficiently small to prevent the conductive element 7 from spinning along an axis perpendicular to the plane of the drawing of FIG. 13 enough to contact the first contact point 15 with the third contact point 21 or the second contact point 17 with the fourth contact point 23. In the Figures, however, the play is not drawn to scale, so as to allow greater clarity in the figures.

FIGS. 14 to 16 show another relay designed to be manufactured with EFAB technology. In this case the conductive element 7 moves vertically, in accordance with FIGS. 14 to 16. The use of one or the other movement alternative in the relay depends on design criteria. The manufacturing technology consists in the deposit of several layers. In all Figures the vertical dimensions are exaggerated, which is to say that the physical devices are much flatter than as shown in the figures. Should one wish to obtain larger condenser surfaces it would be preferable to construct the relay with a form similar to that shown in FIGS. 14 to 16 (vertical relay), whilst a relay with a form similar to that shown in FIGS. 12 and 13 (horizontal relay) would be more appropriate should a lesser number of layers be desired. Should certain specific technologies be used (such as those usually known as polyMUMPS, Dalsa, SUMMIT, Tronic's, Qinetiq's, etc) the number of layers will always be limited. The advantage of a vertical relay is that larger surfaces are obtained with a smaller chip area, and this implies much lower activation voltages (using the same chip area).

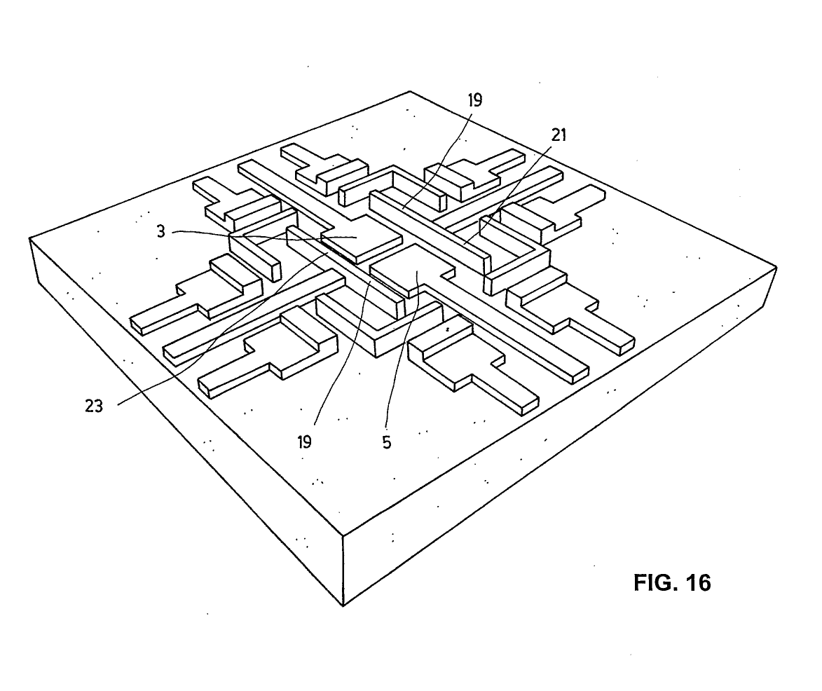

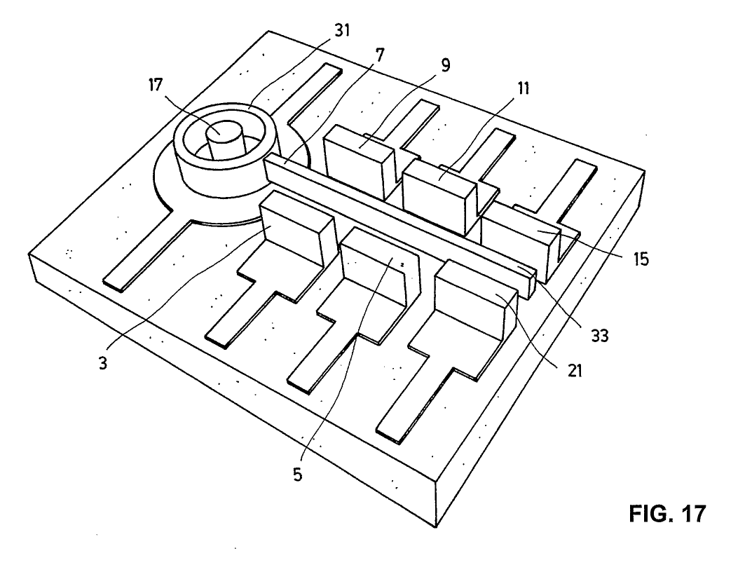

Conceptually the relay of FIGS. 14 to 16 is very similar to the relay of FIGS. 12 and 13, and has the first condenser plate 3 and the fourth condenser plate 5 arranged in the lower part (FIG. 16) as well as the second stops 19 which are the third contact point 21 and the fourth contact point 23. As can be seen in the drawings the second stops 19 are above the condenser plates, such that the conductive element 7 can bear on the second stops 19 without entering into contact with the first and fourth condenser plates 3, 5. In the upper end (FIG. 14) is the second condenser plate 9, the third condenser plate 11 and two first stops 13 which are the first contact point 15 and the second contact point 17. In this case the play between the conductive element 7 and the lateral walls 29 is also sufficiently small to avoid the first contact point 15 contacting with the third contact point 21 or the second contact point 17 contacting with the fourth contact point 23.

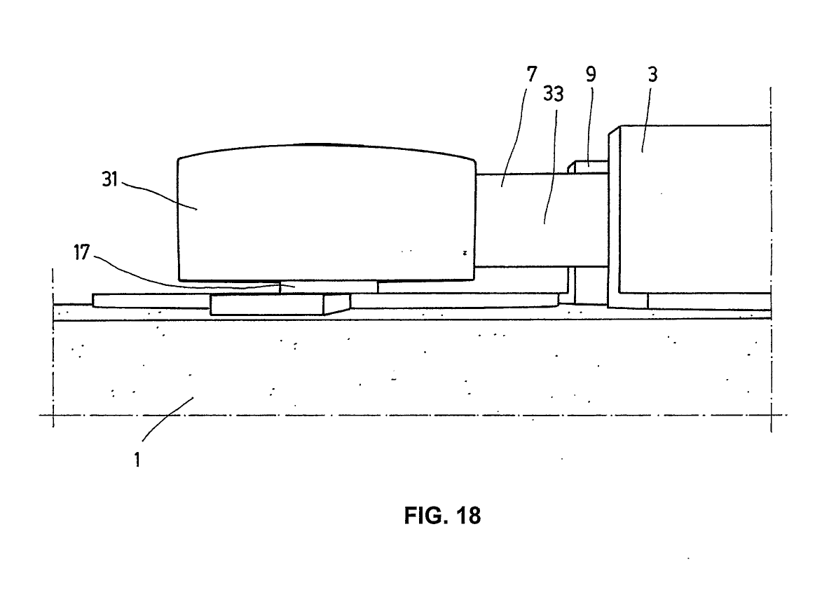

The relay shown in FIGS. 17 and 18 is an example of a relay in which the movement of the conductive element 7 is substantially a rotation around one of its ends. This relay has a first condenser plate 3, a second condenser plate 9, a third condenser plate 11 and a fourth condenser plate 5, all mounted on a substrate 1. Additionally there is a first contact point 15 and a third contact point 21 facing each other. The distance between the first contact point 15 and the third contact point 21 is less than the distance between the condenser plates. The conductive element 7 has a cylindrical part 31 which is hollow, in which the hollow is likewise cylindrical. In the interior of the cylindrical hollow is housed a second contact point 17, having a cylindrical section.

In this manner the conductive element 7 will establish an electrical contact between the first contact point 15 and the second contact point 17 or the third contact point 21 and the second contact point 17. The movement performed by the conductive element 7 is substantially a rotation around the axis defined by the cylindrical part 31. The play between the second contact point 17 and the cylindrical part 31 is exaggerated in the FIG. 17, however it is certain that a certain amount of play exists, the movement performed by the conductive element 7 thus not being a pure rotation but really a combination of rotation and travel.

From the cylindrical part 31 extends a flat part 33 which has a lesser height than the cylindrical part 31, measured in the direction of the axis of said cylindrical part 31. This can be observed in greater detail in FIG. 18, in which is shown a view almost in profile of the cylindrical part 31 and the flat part 33. In this manner one avoids the flat part 33 entering into contact with the substrate 1, which reduces the frictional forces and sticking.

As can be seen, substituting a parallelepipedic part for the cylindrical part 31 and replacing the second contact point 17 having a circular section by one having a quadrangular section, as long as play is sufficient, one can design a relay which is conceptually equivalent to that of FIGS. 17 and 18.

If, for example, in the relay shown in FIGS. 17 and 18 the first contact point 15 and/or the third contact point 21 were eliminated, then it would be the very condenser plates (specifically the third condenser plate 11 and the fourth condenser plate 5) which would serve as contact points and stops. By means of a suitable choice of voltages at which the condenser plates must work one can obtain that this voltage be always VCC or GND. Another possibility would be, for example, that the third contact point 21 were not electrically connected to any external circuit. Then the third contact point would only be a stop, and when the conductive element 7 contacts the second contact point 17 with the third contact point 21, the second contact point 17 would be in a state of high impedance in the circuit.

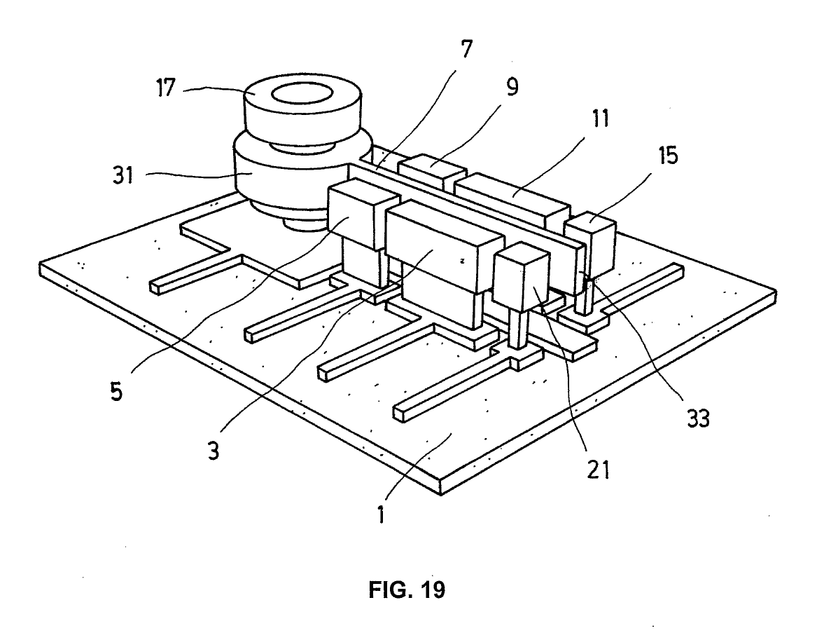

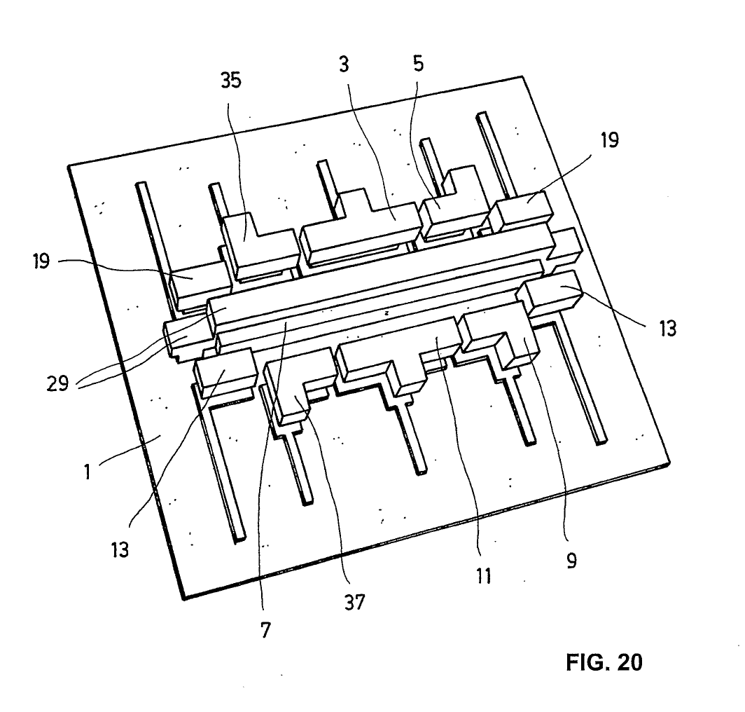

The relay shown in FIG. 19, is designed to be manufactured with polyMUMPS technology. As already mentioned, this technology is known by a person skilled in the art, and is characterised by being a surface micromachining with 3 structural layers and 2 sacrificial layers. However, conceptually it is similar to the relay shown in FIGS. 17 and 18, although there are some differences. Thus in the relay of FIG. 19 the first condenser plate 3 is equal to the third condenser plate 11, but is different from the second condenser plate 9 and the fourth condenser plate 5, which are equal to each other and smaller than the former. With respect to the second contact point 17 it has a widening at its upper end which permits retaining the conductive element 7 in the intermediate space 25. The second contact point 17 of FIGS. 17 and 18 also can be provided with this kind of widening. It is also worth noting that in this relay the distance between the first contact point 15 and the third contact point 21 is equal to the distance between the condenser plates. Given that the movement of the conductive element 7 is a rotational movement around the second contact point 17, the opposite end of the conductive element describes an arc such that it contacts with first or third contact point 15, 21 before the flat part 33 can touch the condenser plates.

FIG. 20 shows another relay designed to be manufactured with polyMUMPS technology. This relay is similar to the relay of FIGS. 12 and 13, although it has, additionally, a fifth condenser plate 35 and a sixth condenser plate 37.

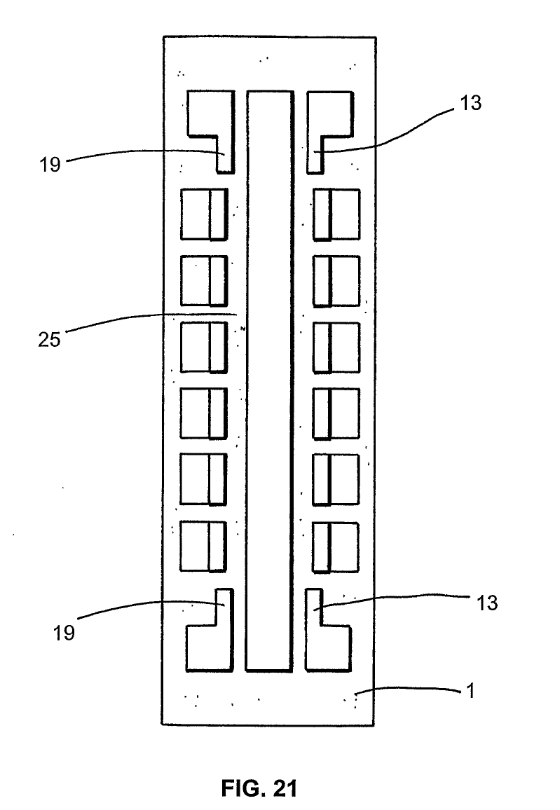

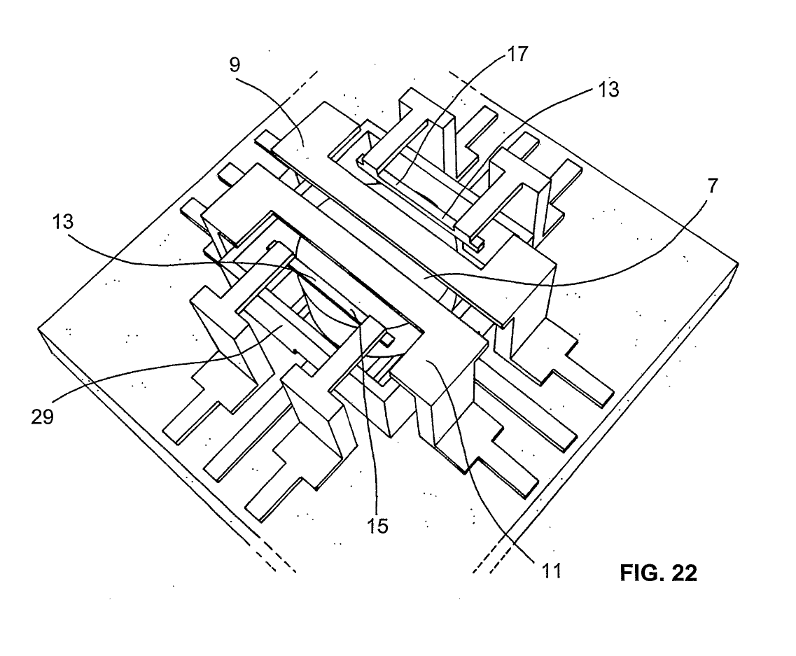

FIG. 21 illustrates a relay equivalent to that shown in FIGS. 12 and 13, but which has six condenser plates in the first zone and six condenser plates in the second zone. Additionally, one should note the upper cover which avoids exit of the conductive element 7.

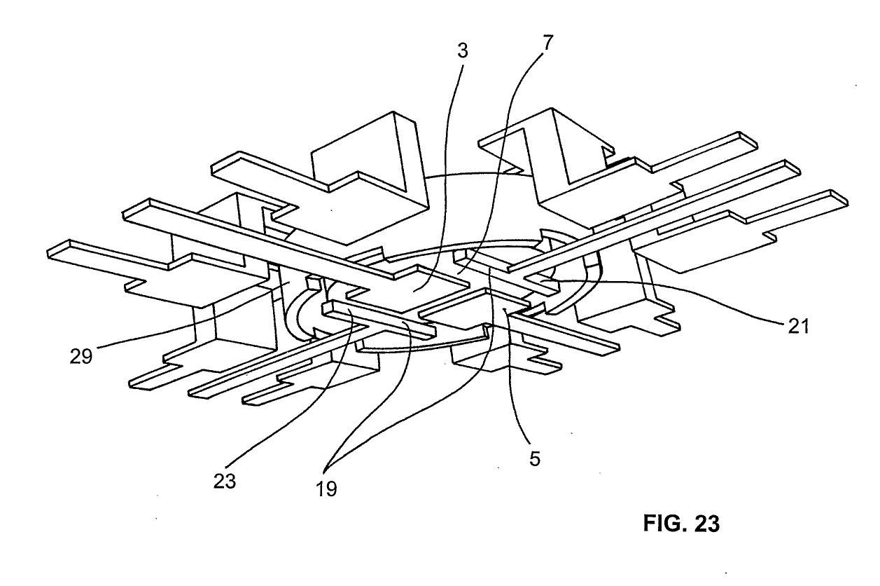

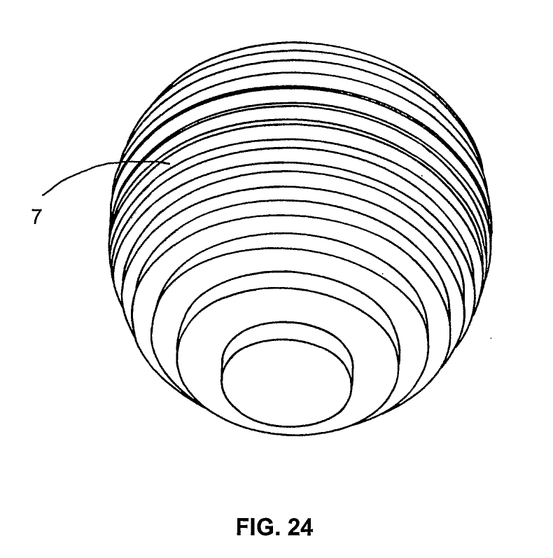

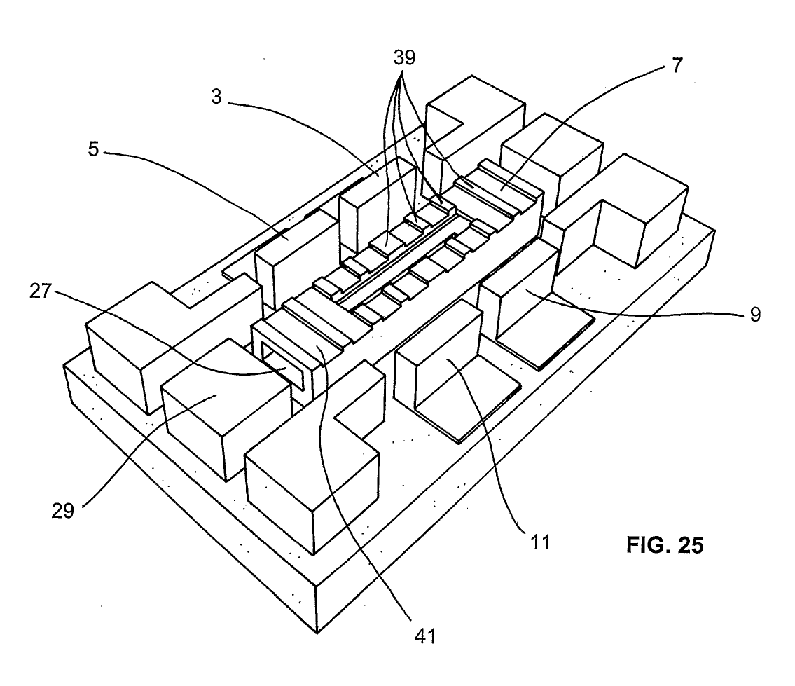

FIGS. 22 and 23 illustrate a relay in which the conductive element 7 is cylindrical. Referring to the relay of FIG. 22, the lateral walls 29 which surround the conductive element are parallelepipedic, whilst in the relay of FIG. 23 the lateral walls 29 which surround the conductive element 7 are cylindrical. With respect to FIG. 24, it shows a sphere manufactured by means of surface micromachining, it being noted that it is formed by a plurality of cylindrical discs of varying diameters. A relay with a spherical conductive element 7 such as that of FIG. 24 can be, for example, very similar conceptually to that of FIGS. 22 or 23 replacing the cylindrical conductive element 7 by a spherical one. Should be taken only into account certain geometric adjustments in the arrangement of the condenser plates and the contact points in the upper end, to avoid the spherical conductive element 7 first touching the condenser plates and not the contact points or, as the case may be, the corresponding stops.

FIG. 25 shows a variant of the relay illustrated in FIGS. 12 and 13. In this case the conductive element 7 has protuberances 39 in its lateral faces 41.

1-40. (canceled)

41. Integrated circuit comprising:
at least an analog connection matrix, having said analog connection matrix a plurality of analog i/o contacts, having said analog i/o contacts a plurality of electric interconnections with respect to one another through connection elements, wherein each of said analog i/o contacts can be either used as input or as output, wherein each of at least two of said analog i/o contacts can be connected with at least one of a group of at least two of the other analog i/o contacts, wherein the established connections can be reversible, wherein said connection elements are miniaturized relays, each of said miniaturized relays including a conductive element arranged in an intermediate space, being said conductive element suitable for effecting a movement between a first position and a second position depending on an electrostatic control signal and said conductive element opening or closing an electric circuit depending on whether it is in said first position or said second position, and wherein at least one of said electric interconnections is formed by more than one miniaturized relay, and by at least one internal node of interconnection.

42. Integrated circuit comprising:
at least an analog connection matrix, having said analog connection matrix a plurality of analog i/o contacts, having said analog i/o contacts a plurality of electric interconnections with respect to one another through connection elements, wherein each of said analog i/o contacts can be either used as input or as output, wherein each of at least two of said analog i/o contacts can be connected with at least one of a group of at least two of the other analog i/o contacts, wherein the established connections can be reversible, wherein said connection elements are miniaturized relays, each of said miniaturized relays including a conductive element arranged in an intermediate space, being said conductive element suitable for effecting a movement between a first position and a second position depending on an electrostatic control signal and said conductive element opening or closing an electric circuit depending on whether it is in said first position or said second position, said integrated circuit further including at least a second analog connection matrix, having said second analog connection matrix a plurality of second analog i/o contacts, having said second analog i/o contacts a plurality of electric interconnections with respect to one another through second connection elements, wherein each of said second analog i/o contacts can be either used as input or as output, wherein each of at least two of said second analog i/o contacts can be connected with at least one of a group of at least two of the other second analog i/o contacts, wherein the established connections can be reversible, wherein said second connection elements are miniaturized relays, wherein each of the miniaturized relays includes a conductive element arranged in an intermediate space, said conductive element being suitable for effecting a movement between a first position and a second position depending on an electrostatic control signal and said conductive element opening or closing an electric circuit depending on whether it is in said first position or in said second position, and wherein a plurality of analog i/o contacts are electrically connected to a plurality of said second analog i/o contacts.

43. Integrated circuit according to claim 41, further comprising:
at least a second analog connection matrix, having said analog connection matrix a plurality of second analog i/o contacts, having said analog i/o contacts a plurality of electric interconnections with respect to one another through second connection elements, wherein each of said second analog i/o contacts can be either used as input or as output, wherein each of at least two of said second analog i/o contacts can be connected with at least one of a group of at least two of the other second analog i/o contacts, wherein the established connections can be reversible, wherein said second connection elements are miniaturized relays, wherein each of the miniaturized relays includes a conductive element arranged in an intermediate space, said conductive element being suitable for effecting a movement between a first position and a second position depending on an electrostatic control signal and said conductive element opening or closing an electric circuit depending on whether it is in said first position or in said second position, and wherein a plurality of analog i/o contacts are electrically connected to a plurality of said second analog i/o contacts.

44. Integrated circuit according to claim 41, wherein each of said analog i/o contacts has an electric interconnection with all and each of the remaining i/o analog contacts.

45. Integrated circuit according to claim 44, wherein each of said second analog i/o contacts has an electric interconnection with all and each of the remaining second analog i/o contacts.

46. Integrated circuit according to claim 41, wherein at least one of said analog i/o contacts lacks an electric interconnection with at least one of the remaining i/o contacts.

47. Integrated circuit according to claim 41, further comprising a control circuit of said miniaturized relays and control i/o contacts.

48. Integrated circuit according to claim 41, wherein each of said electric interconnections is formed by a single miniaturized relay.

49. Integrated circuit according to claim 41, wherein said miniaturized relay comprises:
a first zone facing a second zone,
a first condenser plate,
a second condenser plate arranged in said second zone, in which said second plate is smaller than or equal to said first plate,
said intermediate space arranged between said first zone and said second zone,
said conductive element arranged in said intermediate space, said conductive element being mechanically independent from said first zone and second zone and being suitable for effecting a movement across said intermediate space depending on voltages present in said first and second condenser plates,
a first contact point of an electric circuit, a second contact point of said electric circuit, in which said first and second contact points define first stops, in which said conductive element is suitable for entering into contact with said first stops and in which said conductive element closes said electric circuit when in contact with said first stops.

50. Integrated circuit according to claim 49, wherein said first contact point is between said second zone and said conductive element.

51. Integrated circuit according to claim 49, wherein said first plate is in said second zone.

52. Integrated circuit according to claim 49, wherein said first plate is in said first zone.

53. Integrated circuit according to claim 49, wherein said second contact point is in said second zone.

54. Integrated circuit according to claim 52, further comprising a third condenser plate arranged in said second zone, in which said third condenser plate is smaller than or equal to said first condenser plate, and in which said second and third condenser plates are, together, larger than said first condenser plate.

55. Integrated circuit according to claim 52, further comprising a third condenser plate arranged in said second zone and a fourth condenser plate arranged in said first zone, in which said first condenser plate and said second condenser plate are equal to each other, and said third condenser plate and said fourth condenser plate are equal to each other.

56. Integrated circuit according to claim 55, wherein said first, second, third and fourth condenser plates are all equal to each other.

57. Integrated circuit according to claim 55, further comprising a fifth condenser plate arranged in said first zone and a sixth condenser plate arranged in said second zone, in which said fifth condenser plate and said sixth condenser plate are equal to each other.

58. Integrated circuit according to claim 57, further comprising six condenser plates arranged in said first zone and six condenser plates arranged in said second zone.

59. Integrated circuit according to claims 49, further comprising a second stop between said first zone and said conductive element.

60. Integrated circuit according to claim 49, further comprising a third contact point arranged between said first zone and said conductive element, in which said third contact point defines a second stop, such that said conductive element closes a second electric circuit when in contact with said second contact point and said third contact point.

61. Integrated circuit according to claim 60, wherein said conductive element comprises a hollow cylindrical part which defines an axis, in the interior of which is housed said second contact point, and a flat part which protrudes from one side of said radially hollow cylindrical part and which extends in the direction of said axis, in which said flat part has a height, measured in the direction of said axis, which is less than the height of said cylindrical part measured in the direction of said axis.

62. Integrated circuit according to claim 60, wherein said conductive element comprises a hollow parallelepipedic part which defines an axis, in the interior of which is housed said second contact point, and a flat part which protrudes from one side of said radially hollow paralelepipedic part and which extends in the direction of said axis, in which said flat part has a heights, measured in the direction of said axis, which is less than the height of said parallelepipedic part, measured in the direction of said axis.

63. Integrated circuit according to claim 49, further comprising a third contact point and a fourth contact point arranged between said first zone and said conductive element, in which said third contact point and fourth contact point define second stops, such that said conductive element closes a second electric circuit when in contact with said third contact point and fourth contact point.

64. Integrated circuit according to claim 49, wherein each of assemblies of said condenser plates arranged in each of said first and second zones has central symmetry with respect to a center of symmetry, and in which said center of symmetry is superposed to the center of masses of said conductive element.

65. Integrated circuit according to claim 49, wherein the assembly of said condenser plates arranged in each of said first and second zones has central asymmetry, thus generating a moment of forces with respect to the center of masses of said conductive element.

66. Integrated circuit according to claim 63, wherein between said first zone and said second zone extend two lateral walls, in which there is play between said lateral walls and said conductive element, said play being sufficiently small so as to geometrically prevent said conductive element from simultaneously entering into contact with a contact point of the group formed by said first and second contact points and with a contact point of the group formed by said third and fourth contact points.

67. Integrated circuit according to claim 49, wherein said conductive element has rounded external surfaces.

68. Integrated circuit according to claim 67, wherein said conductive element is cylindrical.

69. Integrated circuit according to claim 67, wherein said conductive element is spherical.

70. Integrated circuit according to claim 49, wherein said conductive element has an upper face and a lower face, said upper and lower faces being perpendicular to said movement of said conductive element, and at least one lateral face, in which said lateral face has slight protuberances.

71. Integrated circuit according to claim 49, wherein said conductive element is hollow.

72. Integrated circuit according to claim 51, wherein said first condenser plate and said second condenser plate have the same surface area.

73. Integrated circuit according to claim 52, wherein said first condenser plate has a surface area which is equal to or double the surface area of said second condenser plate.

74. Integrated circuit according to claim 49, wherein one of said condenser plates is, simultaneously one of said contact points.

75. Integrated circuit according to claim 41, further comprising a plurality of electric elements electrically connected to said analog connection matrix, in which said electric elements are selected from a group of active elements and passive elements.

76. Integrated circuit according to claim 75, further comprising at least an additional electric element, said additional electric element being selected from a group of sensors, power supplies, actuators and antennas.

77. Integrated circuit according to claim 75, further comprising a programmable digital circuit.

78. Printed circuit comprising at least an integrated circuit according to claims 41 or 42, and a plurality of electric elements electrically connected to said analog connection matrix, in which said electric elements are electric elements selected from a group of active elements and passive elements.

79. Printed circuit according to claim 78, further comprising at least an additional electric element, said additional electric element being selected from a group of sensors, power supplies, actuators and antennas.

80. Printed circuit according to claim 78, further comprising a programmable digital circuit.

81. Printed circuit according to claim 79, further comprising a programmable digital circuit.
